(19) United States
(12) Patent Application Publication
(10) Pub. No.: US 2024/0418420 A1
(43) Pub. Date: Dec. 19, 2024

(54) AIR CONDITIONER

(71) Applicants: LG ELECTRONICS INC., Seoul (KR); ACE R & A Co,, LTD., Gyunggi-do (KR)

(72) Inventors: Giung HWANG, Seoul (KR); Sangkyoung PARK, Seoul (KR); Jinseob NOH, Seoul (KR); Taekyoung PARK, Gyunggi-do (KR)

(21) Appl. No.: 18/739,720

(22) Filed: Jun. 11, 2024

(30) Foreign Application Priority Data
Jun. 14, 2023 (KR) 10-2023-0076263

(51) Int. Cl. F25B 43/00; F24F 1/26; F25B 41/40

(52) U.S. Cl. CPC F25B 43/003; F24F 1/26; F25B 41/40; F25B 2400/04

(57) ABSTRACT

An air conditioner may include a main body including a case, a first fan that is disposed inside of the case and supplies air to an indoor space, and a heat exchange coil that is disposed inside of the case and controls a temperature of flowing air, and a piping module fixedly disposed on an outside of the case and connected to the heat exchange coil. The piping module may include a first vertical pipe connected to one side of the heat exchange coil and extending away from the case, a horizontal pipe connected to one side of the first vertical pipe and disposed in parallel with the case, and a strainer disposed in the horizontal pipe and configured to collect foreign substances contained in a flowing fluid. The horizontal pipe may include a main pipe, a bypass pipe connected in parallel to the main pipe, a pair of main pipe valves configured to open and close a main pipe internal flow path, and a bypass pipe valve configured to open and close a bypass pipe internal flow path. The strainer may be disposed in the main pipe between the pair of main pipe valves.

### CROSS-REFERENCE TO RELATED APPLICATION(S)

This application claims priority under 35 U.S.C. § 119 to Korean Application No. 10-2023-0076263 filed in Korea on Jun. 14, 2023, whose entire disclosure is hereby incorporated by reference.

### BACKGROUND

### 1. Field

An air conditioner is disclosed herein.

### 2. Background

An air conditioner is a device that exchanges heat with internally circulating air or external air and supplies the air to an indoor space. An air handling unit may be used as a device to control temperature and humidity inside of a large space.

The air handling unit supplies fresh air by suctioning outside air into a building, for example, and can heat or cool the air supplied from the outside and supply the heated or cooled air to the indoor space. Additionally, humidity may be increased in the air supplied indoors.

The air handling unit may be mainly used in commercial or industrial buildings, so a size and scale thereof may be differentiated depending on a size of the indoor space. Moreover, the air handling unit may be used to control the internal air of a large indoor space.

When installing the air handling unit, an additional pipe connecting to a heat exchange coil may be installed outside of a case in which a ventilation device is disposed. For additional installation work of the pipe, a separate space must be prepared for pipe-related components, and pipes and other components must be fastened through processes, such as cutting and welding, to match the size of the air handling unit. This process has the problem of requiring a separate space for the components for installation and requiring additional time for installation.

Korea Laid-Open Patent Publication No. 10-2023-0056083, which is hereby incorporated by reference, discloses an air handling unit, but does not mention anything related to a pipe installed outside of a case.

### BRIEF DESCRIPTION OF THE DRAWINGS

Embodiments will be described in detail with reference to the following drawings in which like reference numerals refer to like elements, and wherein:

FIG. 1 is a perspective view of an air conditioner according to an embodiment;

FIG. 2 is a cross-sectional view of an air conditioner according to an embodiment;

FIG. 3 is a diagram for explaining a configuration and arrangement of a heat exchange coil according to an embodiment;

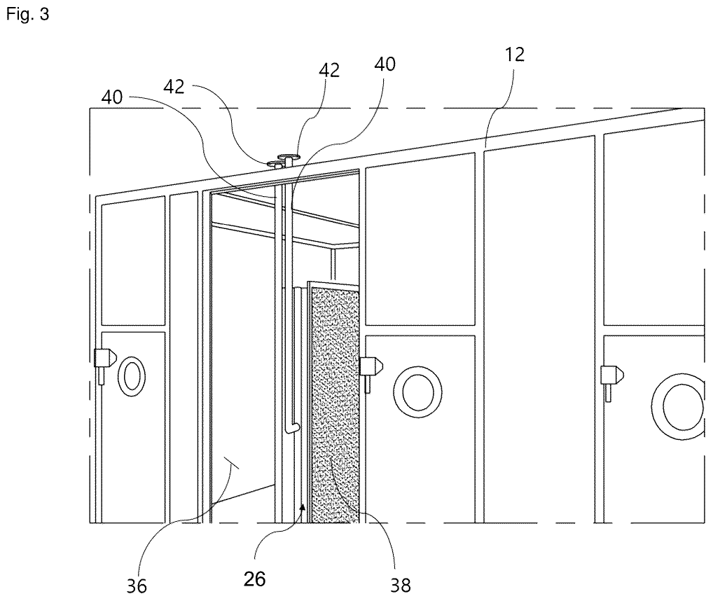

FIG. 4 is a perspective view of a piping module according to an embodiment;

FIG. 5 is a plan view of the piping module of FIG. 4;

FIG. 6 is an exploded view of a portion of the piping module of FIG. 4;

FIG. 7 is a perspective view of a frame according to an embodiment;

FIG. 8 is an exploded perspective view of the frame, piping module, and a clamp according to an embodiment;

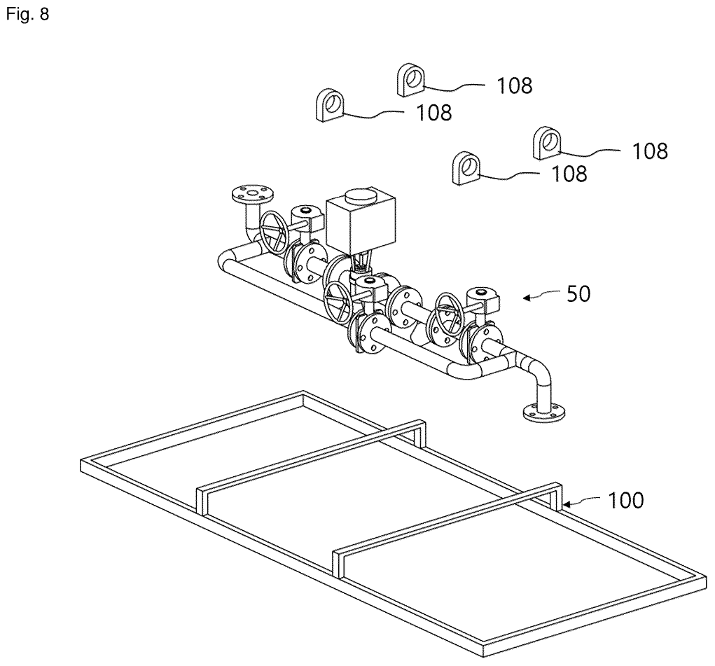

FIG. 9 is a perspective view of a piping module according to another embodiment; and

FIG. 10 is a perspective view of an air conditioner according to another embodiment.

### DETAILED DESCRIPTION

Advantages and features of embodiments, and how to achieve them, will become clear by referring to the embodiments described hereinafter along with the accompanying drawings. However, the embodiments are not limited to the embodiments disclosed hereinafter and may be implemented in various different forms. These embodiments are provided solely to ensure that the disclosure is complete and to completely inform those skilled in the art of the scope of the disclosure to which the embodiments belong, and the embodiments are defined only by the scope of the claims. Like reference numerals refer to like elements throughout the specification.

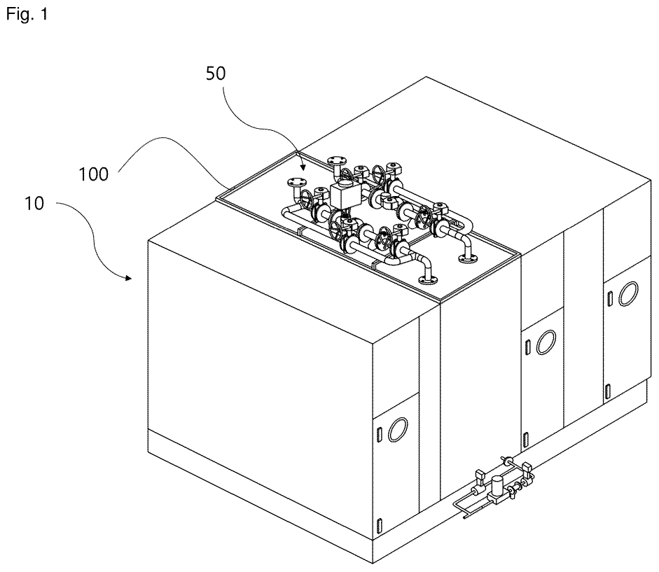

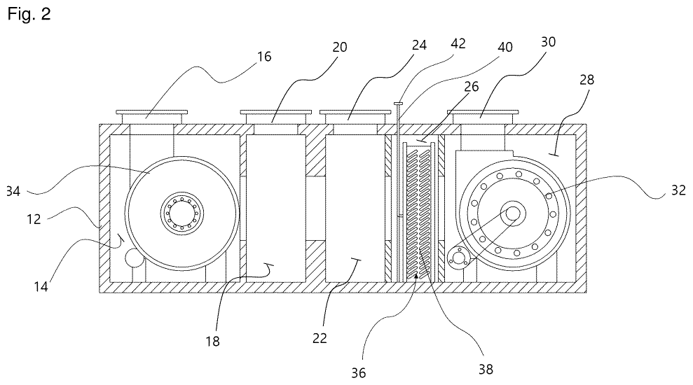

Hereinafter, an air conditioner according to an embodiment will be described with reference to the drawings. Hereinafter, an overall structure of the air conditioner will be described with reference to FIGS. 1 and 2. The air conditioner according to embodiments may include an air handling unit that exchanges heat with outdoor air and supplies the air to an inside space.

Referring to FIG. 1, an air conditioner according to embodiments may include a main body 10 that exchanges heat with outdoor air and supplies the air to an indoor space, and a piping module 50 connected to a heat exchange coil 36 disposed on one side of the main body 10 and disposed inside of the main body 10. Referring to FIG. 1, the piping module 50 according to embodiments may be fixedly disposed on one side of the main body 10 and may include a frame 100 that fixes an arrangement of the piping module 50.

Referring to FIG. 2, the main body 10 may include a case 12 that forms an exterior of the air conditioner. A first fan 32 may be disposed inside of the case 12 and supply air to the indoor space. A second fan 34 may be disposed inside of the case 12 and introduces air outside of the case 12 into the case 12. A heat exchange coil 36 may be disposed inside of the case 12 and exchange heat with air flowing inside of the case 12.

Referring to FIG. 2, an interior of the case 12 may be divided into a plurality of areas. An inside of the case 12 may include a first inlet chamber 14 in which the second fan 34 may be disposed, an exhaust chamber 18 that is disposed on or at one side of the first inlet chamber 14 and discharges the introduced air to the outside, a second inlet chamber 22 which is disposed on or at one side of the exhaust chamber 18 and into which outside air flows, a heat exchange chamber 26 which is disposed on or at one side of the second inlet chamber 22 and in which the heat exchange coil 36 may be disposed, and an air supply chamber 28 in which the first fan 32 may be disposed. A plurality of partition walls may be disposed inside of the case 12 to partition each of the plurality of chambers.

When the second fan 34 operates, air in the indoor space may flow into the first inlet chamber 14. A first inlet damper 16 may be disposed on or at one side of the first inlet chamber 14. The air in the indoor space may flow into the first inlet chamber 14 through the first inlet damper 16.

The exhaust chamber 18 may communicate with the first inlet chamber 14. The exhaust chamber 18 may be disposed between the first inlet chamber 14 and the second inlet chamber 22. The exhaust chamber 18 may communicate with the second inlet chamber 22. An exhaust damper 20 may be disposed on or at one side of the exhaust chamber 18.

Air in the exhaust chamber 18 may be discharged to the outside through the exhaust damper 20. Air flowing from the first inlet chamber 14 to the exhaust chamber 18 may be discharged to the outside through the exhaust damper 20. Additionally, a portion of the air flowing from the first inlet chamber 14 to the exhaust chamber 18 may flow into the second inlet chamber 22.

External air or air from the exhaust chamber 18 may be introduced into the second inlet chamber 22. The second inlet chamber 22 may supply air to the heat exchange chamber 26. A second inlet damper 24 through which external air flows may be disposed on or at one side of the second inlet chamber 22.

The heat exchange coil 36 may be disposed inside of the heat exchange chamber 26. A fluid for controlling a temperature of air flowing through the heat exchange chamber 26 may flow inside the heat exchange coil 36. The fluid flowing through the heat exchange coil 36 may be, for example, water.

The heat exchange coil 36 may include a plurality of coils through which the fluid flows. The heat exchange coil 36 may include a heat exchange coil body 38 disposed inside of the heat exchange chamber 26, a heat exchange coil extension pipe 40 that extends from the heat exchange coil body 38 and protrudes out of the case 12, and a piping connector 42 that is disposed at an end portion of the heat exchange coil extension pipe 40 and connected to the piping module 50. The piping connector 42 may be disposed outside of the case 12. That is, the end portion of the heat exchange coil body 38 may extend through one side of the case 12 to the outside of the case 12, and the piping connector 42 may be disposed at the end portion of the heat exchange coil body 38.

When the first fan 32 operates, the air inside of the air supply chamber 28 may be supplied to the indoor space. The air supply chamber 28 may supply the air flowing from the heat exchange chamber 26 to the indoor space.

An air supply damper 30 may be disposed on or at one side of the air supply chamber 28. The air from the air supply chamber 28 may be supplied to the indoor space through the air supply damper 30.

Although not illustrated in the drawings, a dehumidifier (not illustrated) or humidifier (not illustrated) that adjusts a humidity of the air supplied to the air supply damper 30 may be disposed in the air supply chamber 28.

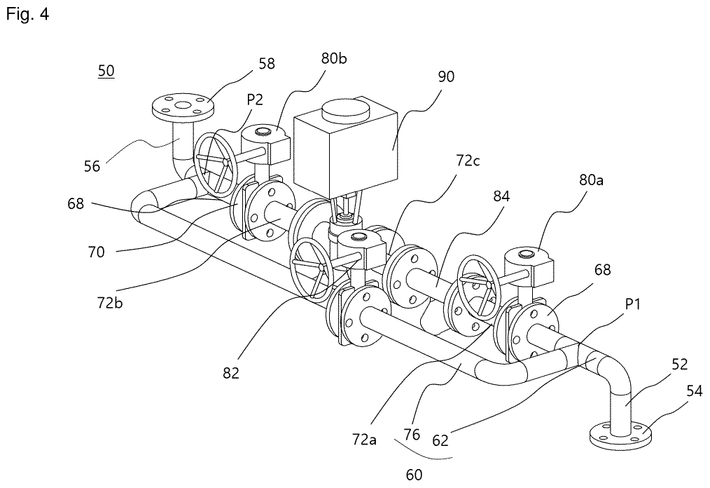

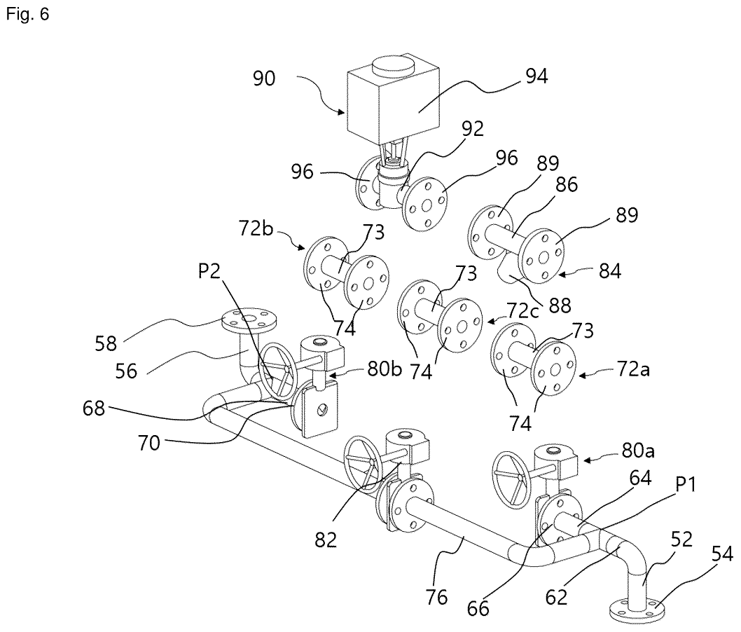

Hereinafter, with reference to FIGS. 4 to 6 and FIG. 9, the piping module 50 according to an embodiment will be described.

The piping module 50 may include a first vertical pipe (first pipe) 52 that is connected to one side of the heat exchange coil 36 and extends away from the case 12, and a horizontal pipe (second pipe) 60 that is connected to one side of the first vertical pipe 52 and disposed side by side in the case 12. The piping module 50 may include a strainer 84 that collects foreign substances contained in the flowing fluid and a flow control valve 90 that controls a flow rate of the fluid flowing through the piping module 50.

The horizontal pipe 60 may be connected to the first vertical pipe 52 on or at one or a first side. A portion where the horizontal pipe 60 and the first vertical pipe 52 are connected may have a banded shape.

The first vertical pipe 52 may separate the horizontal pipe 60 from the case 12. Therefore, it may be easy for an operator to check or replace a flow valve 94 or the strainer 84 disposed in the horizontal pipe 60, which will be described hereinafter.

A first end portion connector 54 connected to the piping connector 42 of the heat exchange coil 36 may be disposed on the end portion of the first vertical pipe 52. That is, the piping module 50 may connect the first end portion connector 54 disposed on the end portion of the first vertical pipe 52 to the piping connector 42 to connect the piping module 50 to one side of the main body 10.

Referring to FIG. 4, the piping module 50 may further include a second vertical pipe (third pipe) 56 that is bent and extends from the other or a second side of the horizontal pipe 60. The first vertical pipe 52 may be disposed on the first side of the horizontal pipe 60, and the second vertical pipe 56 may be disposed on the second side of the horizontal pipe 60.

The second vertical pipe 56 may extend in a direction opposite to the first vertical pipe 52 based on the horizontal pipe 60. A second end portion connector 58 may be disposed on an end portion of the second vertical pipe 56. The second vertical pipe 56 may be connected to a heat supply source that supplies heated or cooled fluid to the heat exchange coil 36.

The horizontal pipe 60 may include a main pipe 62 and a bypass pipe 76 connected in parallel to the main pipe 62. The flow valve 94 may be disposed in the main pipe 62 to control a flow rate of the fluid flowing through the heat exchange coil 36. The strainer 84 may be disposed in the main pipe 62 to remove foreign substances from the fluid flowing through the heat exchange coil 36.

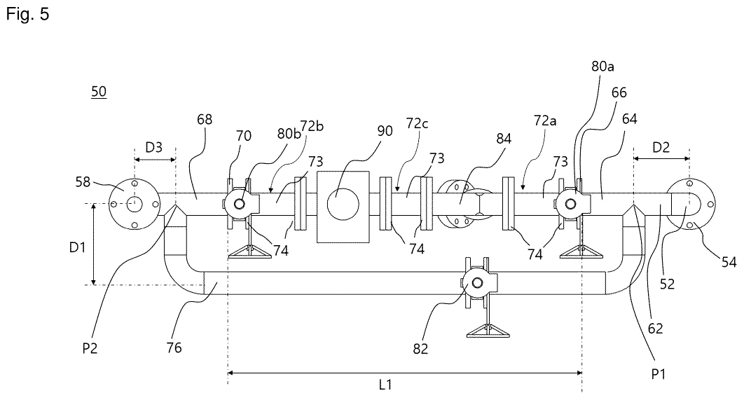

In the main pipe 62, a pair of main pipe valves 80a and 80b that open and close an internal flow path of the main pipe 62 may be disposed. Referring to FIGS. 4 and 5, the pair of main pipe valves 80a and 80b may be spaced apart from each other. The pair of main pipe valves 80a and 80b may be disposed between two points where the bypass pipe 76 is connected to the main pipe 62.

Referring to FIGS. 4 and 5, the bypass pipe 76 may be connected to the main pipe 62 at a first point P1 of the main pipe 62. Additionally, the bypass pipe 76 may be connected to the main pipe 62 at a second point P2 of the main pipe 62. The pair of main pipe valves 80a and 80b may be disposed between the first point P1 and the second point P2.

The flow valve 94 may be disposed between the pair of main pipe valves 80a and 80b. The strainer 84 may be disposed between the pair of main pipe valves 80a and 80b.

The pair of main pipe valves 80a and 80b may include first main pipe valve 80a disposed adjacent to the first vertical pipe 52, and second main pipe valve 80b at a greater distance from the first vertical pipe 52 than the first main pipe valve 80a. The first main pipe valve 80a may be disposed adjacent to the first point P1, and the second main pipe valve 80b is disposed adjacent to the second point P2.

The main pipe 62 may include a first connection pipe 64 which is connected to the first vertical pipe 52 and one side of which is connected to one or a first side of the bypass pipe 76, a second connection pipe 68 one side of which is connected to the other or a second side of the bypass pipe 76, and at least one middle pipe 72a, 72b, or 72c disposed between the first connection pipe 64 and the second connection pipe 68.

The middle pipes 72a, 72b, and 72c may be connected to one end portion of the first connection pipe 64. The middle pipes 72a, 72b, and 72c may be connected to one end portion of the second connection pipe 68. The middle pipes 72a, 72b, and 72c may be connected to the strainer 84 or the flow valve 94. The middle pipes 72a, 72b, and 72c may be connected to each of the pair of main pipe valves 80a and 80b.

At least one of the middle pipes 72a, 72b, or 72c may include a middle pipe body 73 forming a flow path therein, and a pair of middle pipe connectors 74 disposed on both end portions of the middle pipe body 73.

Referring to FIG. 5, the main pipe 62 may include first middle pipe 72a connected to the first connection pipe 64, second middle pipe 72b connected to the second connection pipe 68, and third middle pipe 72c disposed between the first middle pipe 72a and the second middle pipe 72b. The first middle pipe 72a may be connected to the first connection pipe 64 on one or a first side. Referring to FIG. 5, the first middle pipe 72a may be connected to the strainer 84 on the other or a second side.

The first main pipe valve 80a may be disposed between the first connection pipe 64 and the first middle pipe 72a. The first main pipe valve 80a may be fixedly disposed between the first connection pipe 64 and the first middle pipe 72a.

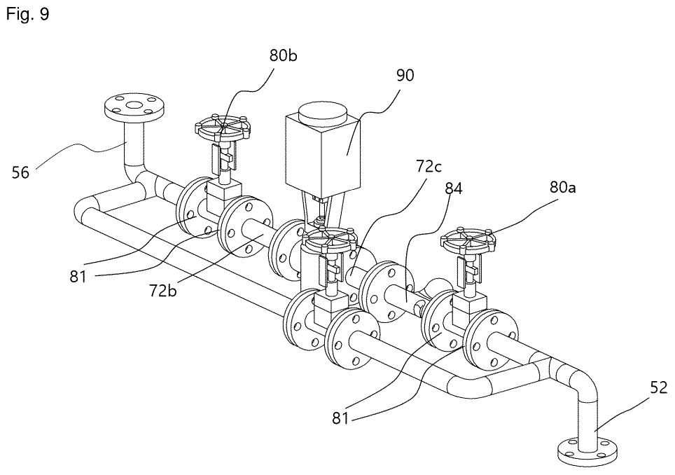

In the embodiment according to FIG. 9, a connector 81 that connects to the first connection pipe 64 or the middle pipe may be disposed in each of the first main pipe valve 80a or the second main pipe valve 80b.

The second middle pipe 72b may be connected to the second connection pipe 68 on one or a first side. Referring to FIG. 5, the second middle pipe 72b may be connected to the flow control valve 90 on the other or a second side.

The second main pipe valve 80b may be disposed between the second connection pipe 68 and the second middle pipe 72b. The second main pipe valve 80b may be fixedly disposed between the second connection pipe 68 and the second middle pipe 72b. The second main pipe valve 80b may be disposed between a second connection pipe connector 70 of the second connection pipe 68 and the connector disposed on the second middle pipe 72b. The third middle pipe 72c may be fixedly disposed between the strainer 84 and the flow control valve 90.

The strainer 84 may include a strainer pipe 86 that forms a flow path inside, and a filter 88 that collects foreign substances from the fluid flowing through the strainer pipe 86. The filter 88 may be disposed in a direction toward the case 12. A pair of strainer connectors 89 coupled to the middle pipes 72a, 72b, and 72c may be disposed on each of both end portions of the strainer pipe 86.

The flow control valve 90 may include a valve pipe 92, the flow valve 94 that controls a diameter of the flow path inside of the valve pipe 92, and a pair of valve pipe connectors 96 disposed on both ends of the valve pipe 92.

A first connection pipe connector 66 may be disposed at one end of the first connection pipe 64. The first connection pipe connector 66 may have a structure connected to one of the pair of middle pipe connectors 74 disposed on the middle pipes 72a, 72b, and 72c.

The bypass pipe 76 may have a structure that branches off from the main pipe 62 on one or a first side and joins the main pipe 62 on the other or a second side. A bypass pipe valve 82 that opens and closes an internal flow path of the bypass pipe 76 may be disposed in the bypass pipe 76.

During a normal operation of the air conditioner, the bypass valve 94 may close the flow path inside of the bypass pipe 76 to allow fluid to flow into the main pipe 62. However, when checking or replacing the flow control valve 90 or strainer 84, the pair of main pipe valves 80a and 80b may close the internal flow path of the main pipe 62 to introduce the flow of the fluid to the bypass pipe 76.

The piping module 50 may be mounted on the outside of the case 12 as one unit. Therefore, when installing an air conditioner, inconvenience of workers working and installing the pipes, the flow control valve 90, and the strainer 84 may be reduced.

Based on a flow direction of the fluid flowing through the main pipe 62, the strainer 84 may be disposed upstream of the flow control valve 90. Accordingly, the fluid flowing into the flow control valve 90 may have foreign substances removed through the strainer 84. That is, the fluid flowing through the main pipe 62 may pass through the strainer 84 and then flow through the flow control valve 90.

Referring to FIG. 5, a separation distance D1 between the bypass pipe 76 and the main pipe 62 may be formed at a ratio of 0.24 to 0.3 relative to the length L1 of the pair of main pipe valves 80a and 80b spaced apart from each other in the direction in which the main pipe 62 extends.

Referring to FIG. 5, a distance D2 between the first point P1 and a center of the first vertical pipe 52 in a direction in which the main pipe 62 extends may be formed at a ratio of 0.13 to 0.2 relative to a length L1 of the pair of main pipe valves 80a and 80b spaced apart from each other in the direction in which the main pipe 62 extends. The center of the first vertical pipe 52 may refer to a center of the flow path formed in the first vertical pipe 52. Referring to FIG. 5, a distance D3 between the second point P2 and a center of the second vertical pipe 56 in the direction in which the main pipe 62 extends may be formed at a ratio of 0.13 to 0.2 relative to the length L1 of the pair of main pipe valves 80a and 80b spaced apart from each other in the direction in which the main pipe 62 extends.

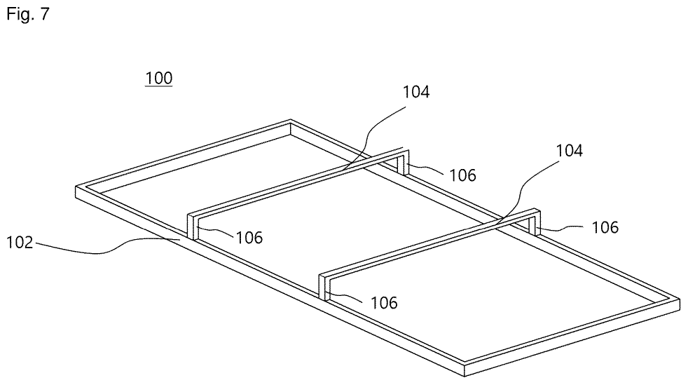

Hereinafter, a frame according to an embodiment will be described with reference to FIG. 7.

The frame 100 may be fixedly disposed on one side of the case 12 and may fix an arrangement of the piping module 50. The frame 100 may include a fixed frame 102 fixed to the case 12, a connection frame 104 connected to the piping module 50, and a spacing frame 106 that separates the connection frame 104 from the fixed frame 102. The fixed frame 102 may have a rectangular frame shape, for example.

The connection frame 104 may have the shape of a bar passing through the main pipe 62 and bypass pipe 76. The connection frame 104 may be provided as a pair spaced apart from each other.

Each of the pair of connection frames 104 may have the shape of a bar that passes through, by, or adjacent to the main pipe 62 and bypass pipe 76. Each of the pair of connection frames 104 may be arranged to intersect each of the main pipe 62 and bypass pipe 76. Each of the main pipe 62 and the bypass pipe 76 may be fixed to each of the pair of connection frames 104 at a point at which they intersect each of the pair of connection frames 104.

The spacing frame 106 may be a height-adjustable structure. The term “height-adjustable structure” refer to a structure for which a height or distance between the fixed frame 102 and the connection frame 104 may be changed. The spacing frame 106 may be adjusted to a required height before being connected to each of the fixed frame 102 and the connection frame 104. It is also possible to adjust the height of the spacing frame 106 by cutting a portion of the structure. Afterwards, the height-adjusted spacing frame 106 may be connected to the fixed frame 102 and the connection frame 104, respectively.

The height-adjustable structure may be a structure in which the spacing frame 106 includes a plurality of structures and the height may be changed while connecting the fixed frame 102 and the connection frame 104. That is, each spacing frame 106 may include a fixing member (not illustrated) and two frames arranged to partially overlap. The fixing member may fix the two frames. Therefore, the height of the spacing frame 106 may be changed by changing an overlap range of the two frames.

The height of the spacing frame 106 may be determined by considering a position at which the main pipe 62 is spaced apart from the case 12.

The spacing frame 106 may have a square frame shape smaller than the fixed frame 102.

The connection frame 104 may be connected to the piping module 50 at four points. The connection frame 104 may be connected to the piping module 50 at two points on the bypass pipe 76 and two points on the main pipe 62.

The air conditioner may further include a clamp 108 that fixes the piping module 50 to the frame 100 and a pad (not illustrated) disposed between the clamp 108 and the piping module 50.

The clamp 108 may fix the piping module 50 to the frame 100. By placing a pad between the clamp 108 and the piping module 50, transmission of vibration generated in the case 12 to the piping module 50 may be minimized.

Referring to FIG. 1, the frame 100 may be fixed to an upper side of the case 12, and the piping module 50 may be disposed thereon.

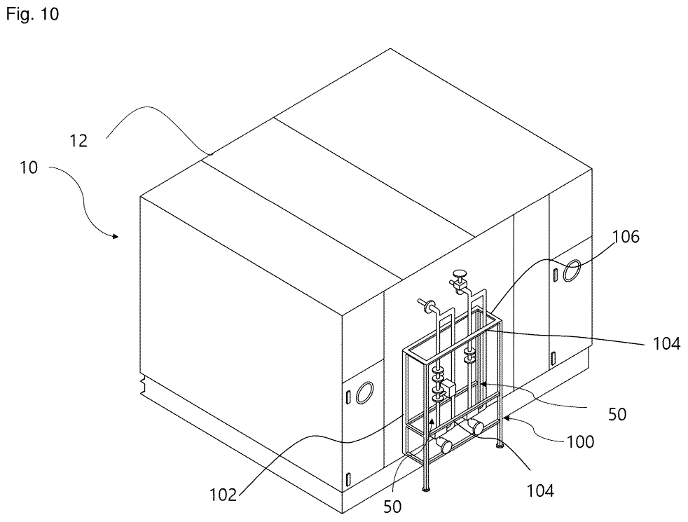

Additionally, as illustrated in FIG. 10, the piping module 50 may be disposed on a side surface of the case 12. In this case, the frame 100 may also be fixedly disposed on the side surface of the case 12 to fix the arrangement of the piping module 50.

Embodiments disclosed herein provide an air conditioner with improved installation of external piping.

Embodiments disclosed herein further provide an air conditioner that may maintain stable arrangement of pipes disposed outside.

Advantages are not limited to the advantages mentioned above, and other advantages not mentioned will be clearly understood by those skilled in the art.

Embodiments disclosed herein provide an air conditioner that may include a main body including a case, a first fan disposed inside of the case and operating to supply air to an indoor space, and a heat exchange coil disposed inside of the case and controlling a temperature of flowing air; and a piping module fixedly disposed on an outside of the case and connected to the heat exchange coil. The piping module may include a first vertical pipe connected to one side of the heat exchange coil and extending away from the case, a horizontal pipe connected to one side of the first vertical pipe and disposed in parallel with the case, and a strainer disposed in the horizontal pipe and configured to collect foreign substances contained in a flowing fluid. The horizontal pipe may include a main pipe, a bypass pipe connected in parallel to the main pipe, a pair of main pipe valves configured to open and close a main pipe internal flow path, and a bypass pipe valve configured to open and close a bypass pipe internal flow path. The strainer may be disposed in the main pipe between the pair of main pipe valves. Therefore, the piping module may be easily coupled to an outside of the case.

The piping module may be easily assembled outside of the case. Further, foreign substances accumulated in the strainer may be easily processed outside of the case.

The pair of main pipe valves may be disposed between two points where the bypass pipe is connected to the main pipe. Thus, a fluid may flow into the bypass pipe through the pair of main pipe valves. Even when the pair of main pipe valves needs to be checked or redisposed, the fluid may flow through the bypass pipe. In other words, the air conditioner may be operated continuously even during a product service process.

A first end portion connector connected to the heat exchange coil may be disposed at an end portion of the first vertical pipe. Therefore, the piping module disposed outside of the case may be easily achieved by connecting the first end portion connector to the heat exchange coil.

The heat exchange coil may include a heat exchange coil body disposed inside of the case and configured to exchange heat with air, a heat exchange coil extension pipe extending from the heat exchange coil body and protruding outside of the case, and a piping connector disposed at an end portion of the heat exchange coil extension pipe and including a piping connector connected to the piping module. The pipe connector may be disposed at a certain or predetermined distance from the case. Therefore, a connection between the piping module and the heat exchange coil may be made outside of the case.

The strainer may include a strainer pipe forming a flow path therein, and a filter configured to collect foreign substances from a fluid flowing through the strainer pipe. The filter may be disposed in a direction toward the case.

A flow control valve may be disposed between the pair of main pipe valves to control a flow rate of a fluid flowing in the main pipe. The flow control valve may be disposed downstream of the strainer in a flow direction of the fluid. Therefore, it is possible to prevent foreign substances from flowing into the flow control valve.

The main pipe may include a first connection pipe connected to the first vertical pipe and connected to one or first side of the bypass pipe on one side, a second connection pipe connected to the other or second side of the bypass pipe on one side, and at least one middle pipe disposed between the first connection pipe and the second connection pipe. The middle pipe may fix an arrangement of the strainer or the flow control valve. Therefore, a plurality of components may be arranged inside of the main pipe.

The air conditioner may further include a frame fixedly disposed on one side of the case and configured to fix an arrangement of the piping module. Therefore, the arrangement of the piping module disposed outside of the case may be fixed.

The frame may include a fixed frame fixed to the case, a connection frame spaced apart from the fixed frame and connected to the piping module, and a spacing frame configured to separate the connection frame from the fixed frame. Therefore, the arrangement of the piping module may be fixed at a position separated from the case.

The spacing frame may be formed in a height-adjustable structure. Therefore, the frame may be adjusted considering an outer shape of the case and a size or shape of the piping module.

The frame may include a pair of connection frames arranged to be spaced apart from each other, and each of the pair of connection frames may be arranged to intersect each of the main pipe and the bypass pipe. Accordingly, the piping module may be stably fixed.

The air conditioner may further include a clamp configured to fix the piping module to the frame.

The piping module may further include a second vertical pipe bent and extending from the other side of the horizontal pipe. The second vertical pipe may extend in a direction opposite to the first vertical pipe with respect to the main pipe. Therefore, the piping module may be connected to a separate heat supply source.

With an air conditioner according to embodiments disclosed herein, one or more of the following advantages may be achieved.

First, there is an advantage that installation of the piping module is improved through the structure of mounting the piping module itself on the outside of the case. In addition, the piping module has a main pipe and bypass pipe structure, allowing the air conditioner to operate even when a part or component of the piping module is redisposed or serviced. In addition, due to the installation of the piping module outside of the case, confirmation, inspection, and replacement of the strainer or flow control valve may be easily performed from outside the case.

Second, there is an advantage that the piping module is fixed to the frame and a stable arrangement may be maintained.

The advantages may not be limited to the advantages mentioned above, and other advantages not mentioned may be clearly understood by those skilled in the art from the description of the claims.

In the above, embodiments have been illustrated and described. However, the embodiments are not limited to the specific embodiments described above, various modifications may be made by a person with ordinary knowledge in the technical field to which the embodiments pertain without departing from the gist as claimed in claims, and these modified implementations should not be understood individually from the technical ideas or perspectives.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioner, comprising:
a main body including a case, a first fan that is disposed inside of the case and supplies air to an indoor space, and a heat exchange coil that is disposed inside of the case and controls a temperature of flowing air; and
a piping module disposed on an outside of the case and connected to the heat exchange coil, wherein the piping module includes:
a first pipe connected to one side of the heat exchange coil and extending away from the case;
a second pipe connected to one side of the first pipe and disposed in parallel with the case; and
a strainer disposed in the second pipe and configured to collect foreign substances contained in a flowing fluid, wherein the second pipe includes:
a main pipe;
a bypass pipe connected in parallel to the main pipe;
a pair of main pipe valves configured to open and close a main pipe internal flow path; and
a bypass pipe valve configured to open and close a bypass pipe internal flow path, and wherein the strainer is disposed in the main pipe between the pair of main pipe valves.

2. The air conditioner of claim 1, wherein the pair of main pipe valves is disposed between two points at which the bypass pipe is connected to the main pipe.

3. The air conditioner of claim 1, wherein a first end portion connector connected to the heat exchange coil is disposed at an end portion of the first pipe.

4. The air conditioner of claim 1, wherein the heat exchange coil includes:
a heat exchange coil body disposed inside of the case and configured to exchange heat with air;
a heat exchange coil extension pipe that extends from the heat exchange coil body and protrudes outside of the case; and
a piping connector disposed at an end portion of the heat exchange coil extension pipe and configured to be connected to the piping module.

5. The air conditioner of claim 4, wherein the pipe connector is disposed at a predetermined distance from the case.

6. The air conditioner of claim 1, wherein the strainer includes a strainer pipe that forms a flow path therein, and a filter configured to collect foreign substances from a fluid flowing through the strainer pipe, and wherein the filter is disposed in a direction toward the case.

7. The air conditioner of claim 1, wherein a flow control valve is disposed between the pair of main pipe valves to control a flow rate of a fluid flowing in the main pipe.

8. The air conditioner of claim 7, wherein the flow control valve is disposed downstream of the strainer in a flow direction of the fluid.

9. The air conditioner of claim 7, wherein the main pipe includes a first connection pipe connected to the first pipe and connected to a first side of the bypass pipe, a second connection pipe connected to a second side of the bypass pipe, and at least one middle pipe disposed between the first connection pipe and the second connection pipe, and wherein the middle pipe fixes an arrangement of the strainer or the flow control valve.

10. The air conditioner of claim 1, further comprising a frame fixedly disposed on one side of the case and configured to fix an arrangement of the piping module.

11. The air conditioner of claim 10, wherein the frame includes:
a fixed frame fixed to the case;
at least one connection frame spaced apart from the fixed frame and connected to the piping module; and
at least one spacing frame configured to separate the connection frame from the fixed frame.

12. The air conditioner of claim 11, wherein the at least one spacing frame is a height-adjustable structure.

13. The air conditioner of claim 11, wherein the at least one connection frame includes a pair of connection frames spaced apart from each other, and wherein each of the pair of connection frames is arranged to intersect each of the main pipe and the bypass pipe.

14. The air conditioner of claim 10, further comprising at least one clamp configured to fix the piping module to the frame.

15. The air conditioner of claim 1, wherein the piping module further includes a third pipe that is bent and extends from a second side of the second pipe, and wherein the third pipe extends in a direction opposite to the first pipe with respect to the main pipe.

16. An air conditioner, comprising:
a main body including a case, a first fan that is disposed inside of the case and supplies air to an indoor space, and a heat exchange coil that is disposed inside of the case and controls a temperature of flowing air;
a piping module disposed on an outside of the case and connected to the heat exchange coil; and
a frame fixedly disposed on the case and configured to couple the piping module to the case, wherein the piping module includes:
a first pipe connected to one side of the heat exchange coil and extending away from the case;
a second pipe connected to one side of the first pipe and disposed in parallel with the case; and
a strainer disposed in the second pipe and configured to collect foreign substances contained in a flowing fluid, wherein the second pipe includes:
a main pipe;
a bypass pipe connected in parallel to the main pipe;
a pair of main pipe valves configured to open and close a main pipe internal flow path; and
a bypass pipe valve configured to open and close a bypass pipe internal flow path, and wherein the strainer is disposed in the main pipe between the pair of main pipe valves.

17. The air conditioner of claim 16, wherein the frame includes:
a fixed frame fixed to the case;
at least one connection frame spaced apart from the fixed frame and connected to the piping module; and
at least one spacing frame configured to separate the connection frame from the fixed frame.

18. The air conditioner of claim 17, wherein the at least one spacing frame is a height-adjustable structure.

19. The air conditioner of claim 17, wherein the at least one connection frame includes a pair of connection frames spaced apart from each other, and wherein each of the pair of connection frames is arranged to intersect each of the main pipe and the bypass pipe.

20. The air conditioner of claim 16, further comprising at least one clamp configured to fix the piping module to the frame.
